(19) United States
(12) Patent Application Publication
(10) Pub. No.: US 2006/0153981 A1
(43) Pub. Date: Jul. 13, 2006

(54) Self-adhesive article comprising at least one layer made from a thermally-conducting adhesive mass and method for production thereof

(76) Inventors: Marc Husemann, Hamburg (DE); Stephan Zollner, Hamburg (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/540,169

(22) PCT Filed: Nov. 24, 2003
(86) PCT No.: PCT/EP03/13168

§ 371 Date: Dec. 5, 2005

(30) Foreign Application Priority Data
Dec. 19, 2002 (DE) 102 59 451.1

(51) Int. Cl. B05D 5/10

(52) U.S. Cl. 427/208.4

(57) ABSTRACT

In a method of producing a pressure-sensitive adhesive article a thermally conductive acrylate-containing pressure-sensitive adhesive is coated within a hotmelt coating process in such a way, with stretching or drawing, onto a backing, that an anisotropic. thermally conductive layer is produced which has a shrinkback of at least 3% measured on the free pressure-sensitive adhesive film.

The invention relates to a method of producing a pressure-sensitive adhesive article having at least one layer of a thermally conductive pressure-sensitive adhesive (PSA) mass, and also to a pressure-sensitive adhesive article obtainable in this way, particularly for adhesive bonds in the field of electrical and electronic components.

In the age of computerization electronic components are more and more being processed and also adhesively bonded to one another. As a result of the miniaturization, the requirements imposed on the pressure-sensitive adhesives are likewise becoming ever more stringent. For instance, very high temperatures can sometimes occur in the electronic circuits, and this heat must in turn be removed. For this application, for example, elements which provide active cooling are bonded. In order to ensure effective heat transition, the adhesive mass must exhibit a very good thermal conductivity. Moreover, the corresponding pressure-sensitive adhesive ought to be suitable for use within a wide temperature range, ought to exhibit low outgassing, and ought to be very stable toward aging. The latter requirements are met very well by acrylate PSAs.

U.S. Pat. No. 4,722,960 blends acrylates with aluminum particles and a free-radical initiator and uses the blend for the purpose of adhesive bonding. In the case of this method, however, a very large amount of time is required for the adhesive bond, since the monomer mixture must be crosslinked thermally.

U.S. Pat. No. 6,228,965 describes an acrylate copolymer mixture which again is blended with a heat-conductive material. In this way it is possible to obtain acrylate PSAs which are likewise heat-conductive and can be used for bonding without a great applied pressure.

As a result of the ever further contracting dimensions and the increasingly close construction of the individual electronic components, however, increasingly more stringent requirements are being imposed on the flow behavior of the PSA. Thus, for example, it is necessary to prevent the situation where, after the adhesive bonding of two electronic components, the PSA runs out at the side and so gives rise to improper operations as a result of bridging to other circuits. This cannot be ensured, however, by the PSAs described in U.S. Pat. No. 6,228,965, for example.

It is an object of the invention, therefore, to provide thermally conductive pressure-sensitive adhesives, in particular for the electrical and electronics industry, with which the disadvantages in the prior art are avoided and, in particular, the outward swelling or outward flow of the pressure-sensitive adhesive at the edge of the bond is reliably avoided.

This object is achieved, surprisingly and in a manner not foreseeable for the skilled worker, by a method by means of which anisotropic, oriented pressure-sensitive adhesives with a shrinkback of at least 3% with coating onto a carrier (including, where appropriate, a temporary carrier from which the pressure-sensitive adhesive can be removed again) are obtained, and also by associated pressure-sensitive adhesive articles obtained in this way. Developments of the invention are characterized in the dependent claims.

The achievement of the object of the invention encompasses a method of producing a pressure-sensitive adhesive article for bonding electrical or electronic parts which has at least one layer of a thermally conductive pressure-sensitive adhesive, i.e., a pressure-sensitive adhesive based on polyacrylates and/or polymethacrylates with or without further comonomers, wherein a layer which is anisotropic at least in respect of one property is produced from the thermally conductive pressure-sensitive adhesive in a coating process by stretching, drawing or compressing, said layer possessing in at least one direction along the plane of the layer a shrinkback of at least 3% in respect of the longitudinal extent of the layer, measured by a shrinkback measurement according to test B on the free film.

Anisotropy means that at least one property of the pressure-sensitive adhesive in one spatial direction within the layer of the PSA differs from the same property in at least one other direction; in other words, anisotropic properties are vectorial and not uniform within the material.

The pressure-sensitive adhesive preferably possesses an orientation as known as such, i.e., a preferential direction within the polymer structure.

The coating process may be for example a hotmelt roll coating process, a melt diecoating process or an extrusion coating process.

In an alternative embodiment of the invention the coating process is a conventional coating process, from solution for example, in which coating is followed by stretching or drawing, preferably on a stretchable carrier.

The thermally conductive pressure-sensitive adhesive can be coated by the coating process onto one or both sides of a sheetlike or tapelike carrier, which may also be a transfer tape or a release liner. The carrier material may itself be thermally conducting in one possible embodiment.

Pressure-Sensitive Adhesives which can be used in Accordance with the Invention

Anisotropic pressure-sensitive adhesives are known per se. They are also referred to below as anisotropically oriented or simply “oriented pressure-sensitive adhesives”.

Anisotropically oriented PSAs possess a tendency, after stretching in a given direction, to move back-into the initial state as a result of their ‘entropy-elastic’ behavior.

In the context of the invention, as PSAs it is preferred to use (meth)acrylate PSAs, or polyacrylate—and/or polymethacrylate-based PSAs, i.e., with a substantial or predominant proportion of polyacrylates and/or polymethacrylates, including associated derivatives.

The monomers are preferably chosen such that the resulting polymers can be used, at room temperature or higher temperatures, as PSAs, particularly such that the resulting polymers possess pressure-sensitive adhesion properties in accordance with the “Handbook of Pressure Sensitive Adhesive Technology” by Donatas Satas (van Nostrand, New York 1989).

The polymers used with preference for the thermally conductive PSAs with resilience can be obtained preferably by polymerizing a monomer mixture which has a high or predominant proportion of acrylic esters and/or methacrylic esters and/or the free acids thereof, with the formula CH₂=CH(R₁)(COOR₂), where R₁ is H or CH₃ and R₂ is an alkyl chain having 1-20 carbon atoms or is H.

The molar masses M_{w} of the polyacrylates used amount preferably to M_{w}≧200 000 g/mol.

In one way which is greatly preferred, acrylic or methacrylic monomers are used which are composed of acrylic and methacrylic esters having alkyl groups comprising 4 to 14 carbon atoms, and preferably comprise 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 carbon atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates and 3,5-dimethyladamantyl acrylate.

In one procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethylmethacrylamide, N-tert-butylacryl-amide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, N-isopropylacrylamide, this enumeration not being exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In one further very preferred procedure use is made as comonomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

In a preferred procedure, use is made, for the polymerization of the polymethacrylate PSA, of photoinitiators having a copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators for use, which can be functionalized with a double bond, is given in Fouassier: “Photoinitiation, Photopolymerization and Photocuring: Fundamentals and Applications”, Hanser-Verlag, Munich 1995. Supplementarily use is made of Carroy et al. in “Chemistry and Technology of UV and EB Formulation for Coatings, Inks and Paints”, Oldring (ed.), 1994, SITA, London.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

With the method according to the invention, a shrink-back of at least 3% is produced in the PSA, the shrinkback being measured as determined by test B (shrinkback measurement in the free film). In preferred developments PSAs are used for which the shrinkback is at least 30%, very preferably at least 50%.

The thermally conductive PSA used in the invention preferably comprises an addition of a thermally conductive compound. In one preferred version, therefore, thermally conductive filler materials are used. Examples of suitable filler materials include various metal particles, ceramics, aluminum oxide, aluminum nitride, titanium boride, boron nitride, and silicon nitride. It is, however, also possible to add all further thermoconductive materials that are known to the skilled worker.

In one inventively preferred version between 5% and 200%, preferably between 6% and 50%, by weight of the thermoconductive material, based on the weight of the PSA, are added to the pressure-sensitively adhesive poly(meth)acrylate, it being necessary, according to the amount and nature of the addition, for the pressure-sensitive adhesion to be ensured in all cases.

The thermal conductivity of the PSA ought to amount to at least 0.05 W/mK. In one preferred version the thermal conductivity is lower in the direction of orientation than in the transverse or cross direction.

For further development it is possible to admix resins to the PSAs. As tackifying resins for addition it is possible without exception to use all existing tackifier resins and those described in the literature. Representatives that may be mentioned include pinene resins, indene resins and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Express reference may be made to the depiction of the state of the art in the “Handbook of Pressure Sensitive Adhesive Technology” by Donatas Satas (van Nostrand, 1989).

In addition it is possible optionally to add plasticizers, further fillers (such as, for example, fibers, carbon black, zinc oxide, chalk, solid or hollow glass beads, microbeads made of other materials, silica, silicates), nucleators, expandants, compounding agents and/or aging inhibitors, in the form of, for example, primary and secondary antioxidants or in the form of light stabilizers.

In an advantageous development of the invention, the PSA may be crosslinked immediately after or during hotmelt coating, preferably photochemically, whereby the oriented state is additionally stabilized, so that the PSA experiences practically no change even over relatively long storage times under nonoptimal conditions. For this purpose it is possible to admix crosslinkers and crosslinking promoters. Examples of suitable crosslinkers for electron beam crosslinking and UV crosslinking include difunctional or polyfunctional acrylates, difunctional or polyfunctional isocyanates (including those in blocked form), and difunctional or polyfunctional epoxides.

For optional crosslinking with UV light it is possible to add UV-absorbing photoinitiators to the PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. For further details it is possible to consult Carroy et al. in “Chemistry and Technology of UV and EB Formulation for Coatings, Inks and Paints”, Oldring (ed.), 1994, SITA, London.

Preparation Processes for the Inventive PSAs

For the polymerization the monomers are chosen such that the resultant polymers can be used at room temperature or higher temperatures as PSAs, particularly such that the resulting polymers possess pressure sensitive adhesion properties in accordance with the “Handbook of Pressure Sensitive Adhesive Technology” by Donatas Satas (van Nostrand, New York 1989).

In order to achieve a preferred polymer glass transition temperature T_{g} of ≦25° C. it is very preferred, in accordance with the comments made above, to select the monomers in such a way, and to choose the quantitative composition of the monomer mixture advantageously in such a way as to result in the desired T_{g} for the polymer in accordance with the Fox equation (E1) (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E1 )$$

In this equation, n represents the serial number of the monomers used, wₙ the mass fraction of the respective monomer n (% by weight) and T_{g,n} the respective glass transition temperature of the homopolymer of each of the monomers n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version the free-radical initiator used is 1,1′-azobis(cyclohexane-carbonitrile) (Vazo 88™ from DuPont) or azodiisobutyronitrile (AIBN).

The thermally conductive materials can be admixed to the monomers before the polymerization and/or after the end of the polymerization.

The average molecular weights M_{w} of the PSAs formed in the free-radical polymerization are very preferably chosen such that they are situated within a range of 200 000 to 4 000 000 g/mol; specifically for further use as thermally conductive hot-melt PSAs with anisotropic behavior, PSAs are prepared which have average molecular weights M_{w} of 400 000 to 1 400 000 g/mol. The average molecular weight is determined by size exclusion chromatography (GPC) or matrix-assisted laser desorption/ionization coupled with mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are straight alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cbsolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter can be the chosen reaction time.

As regards initiation of the polymerization, the introduction of heat is essential for the thermally decomposing initiators. For these initiators the polymerization can be initiated by heating to from 50 to 160° C., depending on initiator type.

For the preparation it can also be of advantage to polymerize the acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylic hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer block of the monomers A. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylic monomers, such as n-butyl acrylate and 2-ethylhexyl acrylate, for example, can be polymerized directly and do not have to be generated in the polymer by transesterification with the corresponding alcohol.

Methods suitable for preparing polyacrylate PSAs with a narrow molecular weight distribution also include controlled free-radical polymerization methods. In that case it is preferred to use, for the polymerization, a control reagent of the general formula: 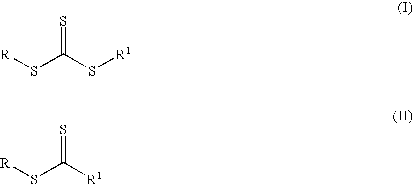
in which R and R¹, chosen independently of one another or identical, are
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one oxygen atom and/or one NR* group in the carbon chain, R* being any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

Control reagents of type (I) are preferably composed of the following further-restricted compounds:

halogen atoms therein are preferably F, Cl, Br or I, more preferably Cl and Br.

Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlbrohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethyl, toluene, xylene, mesitylene, isopropylbenzene, dichlorobenzene or bromotoluene.

The above enumerations serve only as examples of the respective groups of compounds, and make no claim to completeness.

Other compounds which can be used as control reagents include those of the following types: 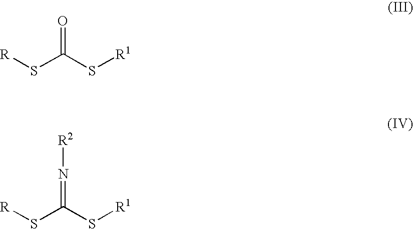
where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hot-melt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb): 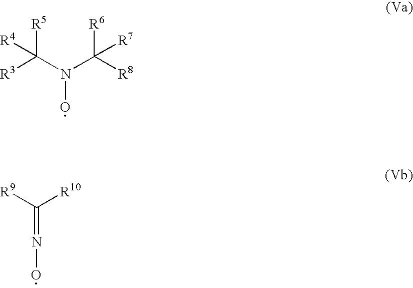
where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of type (Va) or (Vb) can also be attached to polymer chains of any kind (primarily such that at least one of the abovementioned radicals constitutes a polymer chain of this kind) and may therefore be used for the synthesis of polyacrylate PSAs. More preferred are controlled regulators for the polymerization of compounds of the following type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxy pyrrolidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6,-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods in accordance with which the PSAs can be prepared by an alternative procedure can be chosen from the prior art:

U.S. Pat. No. 4,581,429 A discloses a controlled-growth free-radical polymerization process which uses as its initiator a compound of the formula R′R″N—O—Y, in which Y is a free-radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates (Hawker, paper to the National Meeting of the American Chemical Society, Spring 1997; Husemann, paper to the IUPAC World-Polymer Meeting 1998, Gold Coast).

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826698A1; EP 824 110A1; EP 841 346A1; EP 850 957 A1). The various possibilities of ATRP are further described in U.S. Pat. No. 5,945,491 A, U.S. Pat. No. 5,854,364 A and U.S. Pat. No. 5,789,487 A.

Orientation, Coating Processes, Treatment of the Carrier Material with the Thermally Conductive PSA

In order to produce oriented PSAs the polymers described above are coated preferably as hotmelt systems (i.e., from the melt). For the production process it may therefore be necessary to remove the solvent from the PSA. In principle it is possible here to use any of the techniques known to the skilled worker. One very preferred technique is that of concentration using a single-screw or twin-screw extruder. The twin-screw extruder may be operated corotatingly or counterrotatingly. The solvent or water is distilled off preferably by way of two or more vacuum stages. Moreover, counterheating is carried out depending on the distillation temperature of the solvent. The residual solvent fractions are preferably<1%, more preferably<0.5% and very preferably<0.2%. The hotmelt is processed further from the melt.

Orientation within the PSA is produced in the course of coating by means of the coating process. For coating as a hotmelt, and hence also for orientation, it is possible to employ different coating techniques. In one version the thermally conductive PSAs are coated by a roll coating process, and the orientation is produced by drawing. Various roll coating techniques are described in the “Handbook of Pressure Sensitive Adhesive Technology” by Donatas Satas (van Nostrand, New York 1989). In another version the orientation is achieved by coating via a melt die. A distinction can be made here between the contact process and the noncontact process. Orientation of the thermally conductive PSA here can be produced on the one hand within the coating die, by virtue of the die design, or else following emergence form the die, by a drawing operation. The orientation is freely adjustable. The draw ratio can be controlled, for example, by the width of the die gap. Drawing occurs whenever the layer thickness of the PSA film on the carrier material to be coated is less than the width of the die gap.

In another preferred process the orientation is achieved by extrusion coating. Extrusion coating is preferably performed using an extrusion die. The extrusion dies used may originate with advantage from one of the following three categories: T-dies, fishtail dies, and coathanger dies. The individual types differ in the design of their flow channel. Through the form of the extrusion die it is likewise possible to produce an orientation within the hotmelt PSA. Additionally, here, in analogy to melt die coating, it is likewise possible to obtain an orientation following emergence from the die, by drawing the PSA tape film.

In order to produce oriented acrylate PSAs it is particularly preferred to carry out coating onto a carrier using a coathanger die, and specifically in such a way that a polymer layer is formed on the carrier by means of a movement of die relative to carrier. The time which elapses between coating and crosslinking is advantageously small. In one preferred procedure, crosslinking is carried out after less than 60 minutes; in a more preferred procedure, after. less than 3 minutes; and, in a very preferred procedure, in an inline process, after less than 5 seconds.

The carrier material treated with thermally conductive PSA may be a single-sided or a double-sided adhesive tape.

In one version, transfer tapes are produced. Examples of suitable carrier material includes all siliconized or fluorinated films having a release effect. Film materials that may be mentioned here, mainly by way of example, include BOPP, MOPP, PET, PVC, PU, PE, PE/EVA, EPDM, PP and PE. For transfer tapes, moreover, it is also possible to use release papers (glassine papers, kraft papers, polyolefinically coated papers).

Where the carrier material remains in the PSA (in the form of a carrier film, for example) it is preferred to use a carrier material which likewise possesses a high thermal conductivity. For this case too, it is possible to use films which comprise, for example, boron nitrile, aluminum oxide or silicon nitrile. However, it is also possible to use metal foils. Particularly preferred films are composed of aluminum, copper, stainless steel, metal alloyts, etc. Polysilicones are also suitable as carrier film, however.

The best orientation effects are obtained by deposition onto a cold surface. Consequently the carrier material during coating should be cooled directly by means of a roll. The roll can be cooled by a liquid film/contact film from the outside or inside, or by a coolant gas. The coolant gas may likewise be used to cool the PSA emerging from the coating die; In one preferred procedure the roll is wetted with a contact medium, which is then located between the roll and the carrier material. Preferred embodiments for the implementation of such a technique are described later on below.

For this process it is possible to use both a melt die and an extrusion die. In one very preferred procedure the roll is cooled to room temperature, and in an extremely preferred procedure to temperatures below 10° C. The roll ought to rotate as well.

In a further procedure as part of this production process, the roll is used, moreover, for crosslinking of the oriented PSA.

UV crosslinking is effected by irradiation with shortwave ultraviolet radiation in a wavelength range from 200 to 400 nm, depending on the UV photoinitiator used, especially using high-pressure or medium-pressure mercury lamps at an output of 80 to 240 W/cm. The irradiation intensity is adapted to the respective quantum yield of the UV photoinitiator, the degree of crosslinking to be brought about, and the extent of the orientation.

Moreover, it is possible to crosslink the thermoconductive and oriented PSA using electron beams. Typical irradiation equipment which may be used includes linear cathode systems, scanner systems and segmented cathode systems, where electron-beam accelerators are concerned. An extensive description of the state of the art and the most important process parameters are found in Skelhorne, Electron Beam Processing, in Chemistry and Technology of UV and EB formulation for Coatings, Inks and Paints, Vol. 1, 1991, SITA, London. The typical accelerator voltages are situated in the range between 50 kV and 500 kV, preferably 80 kV and 300 kV. The scatter doses employed range between 5 to 150 kGy, in particular between 20 and 100 kGy.

It is also possible to employ both crosslinking methods, or other methods which permit high-energy irradiation.

In a further preferred production process, the thermoconductive and oriented PSAs are coated onto a roll provided with a contact medium. As a result of the contact medium it is possible in turn to carry out very rapid cooling of the PSA. Advantageously, lamination is then carried out onto the carrier material later.

Furthermore, as the contact medium it is also possible to use a material which has the capacity to bring about contact between the PSA and the. roll surface, in. particular a material which fills the cavities between carrier material and roll surface (unevennesses in the roll surface, bubbles, for example). In order to implement this technology, a rotating chill roll is coated with a contact medium. In one preferred procedure the contact medium chosen is a liquid, such as water, for example.

Examples of appropriate additives to water as the contact medium include alkyl alcohols such as ethanol, propanol, butanol and hexanol, without wishing to be restricted in the selection of the alcohols as a result of these examples. Also highly advantageous are, in particular, longer-chain alcohols, polyglycols, ketones, amines, carboxylates, sulfonates and the like. Many of these compounds lower the surface tension or raise the conductivity.

A lowering of the surface tension may also be achieved by adding small amounts of nonionic and/or anionic and/or cationic surfactants to the contact medium. The most simple way of achieving this is by using commercial washing compositions or soap solutions, preferably in a concentration of a few g/l in water, as. the contact medium. Particularly suitable compounds are special surfactants which can be used even at a low concentration. Examples thereof include sulfonium surfactants (e.g., β-di(hydroxyl-alkyl)sulfonium salt), and also, for example, ethoxylated nonylphenylsulfonic acid ammonium salts or block copolymers, especially diblocks. Here, reference may be made in particular to the state of the art under “surfactants” in Ullmann's Encyclopedia of Industrial Chemistry, Sixth Edition, 2000 Electronic Release, Wiley-VCH, Weinheim 2000.

As contact media it is possible to use the aforementioned liquids, even without the addition of water, in each case alone or in combination with one another.

In order to improve the properties of the contact medium (for example, to increase the shearing resistance, reduce the transfer of surfactants or the like to the liner surface, and thus improved cleaning possibilities for the end product), salts, gels and similar viscosity-enhancing additives may also be added with advantage to the contact medium and/or to the adjuvants employed.

Furthermore, the roll can be macroscopically smooth or can have a surface with a low level of structuring. It has been found appropriate for the roll to possess a surface structure, in particular a surface roughening. This allows wetting by the contact medium to be improved.

The coating process runs particularly well if the roll is temperature-controllable, preferably within a range from −30° C. to 200° C, very preferably from 5° C. to 25° C.

The contact medium is preferably applied to the roll. A second roll, which takes up the contact medium, may be used for continuous wetting of the coating roll. It is, however, also possible to carry out contactless application, by spraying, for example.

For the variant of the production process where the roll is employed simultaneously for use, for example, with electron beams it is common to use a grounded metal roll which absorbs the incident electrons and the X-radiation that is formed in the process.

In order to prevent corrosion, the roll is commonly coated with a protective coat. This coat is preferably selected such that it is wetted effectively by the contact medium. In general, the surface is conductive. It may also be more advantageous, however, to coat it with one or more coats of insulating or semiconducting material.

Where a liquid is used as the contact medium, one outstanding procedure possible is to run a second roll, advantageously having a wettable or absorbent surface, through a bath containing the contact medium, said roll then becoming wetted by or impregnated with the contact medium and applying a film of said contact medium by contact with the roll.

In one preferred procedure. the PSA is coated directly on the contact medium roll, and crosslinked. For this purpose it is possible in turn to use the methods and equipment described for UV crosslinking and EB crosslinking. Then, following crosslinking, the thermally conductive and oriented PSA is transferred to a carrier material. The carrier materials already stated may be used.

The characterization of the orientation within the thermally conductive PSAs is dependent on the coating process. The orientation can be controlled, for example, by the die temperature and coating temperature and also by the molecular weight of the polymer.

The degree of orientation is freely adjustable through.the die gap width. The thicker the PSA film extruded from the coating die, the greater the extent to which the adhesive can be drawn to a relatively thin PSA film on the carrier material. This drawing operation may be freely adjusted not only by the freely adjustable die width but also by the web speed of the decreasing carrier material.

The orientation of the adhesive mass can be measured with a polarimeter, by infrared dichroism, or using X-ray scattering. It is known that in many cases the orientation in acrylate PSAs in the uncrosslinked state is retained for only a few days. During rest or, storage, the system relaxes and loses its preferential direction. As a result of crosslinking after coating, this effect can be strengthened significantly. The relaxation of the oriented polymer chains converges toward zero, and the oriented PSAs can be stored for a very long period of time without loss of their preferential direction.

In one preferred method the extent of the orientation is determined by measuring the shrinkback in the free film (see test B).

Besides the processes described, the orientation may also be produced after coating. In that case, then, a stretchable carrier material is preferably used, with the PSA then being drawn during stretching. In this case it is also possible to use PSAs coated conventionally from solution or water. In one preferred procedure, then, this drawn PSA is in turn crosslinked with actinic radiation.

Use

The invention further provides for the use of the thermoconductive and oriented PSAs for bonding components in the electrical and electronics industry. With particular preference the inventive PSA tapes are used for bonding cooling units to hot electrical or electronic components. The resilience of the PSA prevents it from running out at the edge in a preferential direction after bonding, or minimizes this. This process is further accelerated by the temperature effect of the electrical/electronic component. Furthermore, the thermoconductive particles within the PSA are likewise oriented by the stretching and pulled apart in a preferential direction. As a result of this process the thermal conductivity in the direction of orientation is lowered, so that the PSAs and hence also the corresponding PSA tapes generally have an anisotropic thermal conductivity.

In a further preferred embodiment of the invention, the inventive PSA tape has no electrical conductivity.

### EXAMPLES

The invention is illustrated below by means of examples and experiments.

The following test methods were employed for investigating the samples:

Gel Permeation Chromatography GPC (Test A)

The average molecular weight M_{w} and the polydispersity PD were determined by gel permeation chromatography. The eluent used was THF containing 0.1% by volume trifluoroacetic acid. Measurement took place at 25° C. The precolumn used was PSS-SDV, 5μ, 10² Å, ID 8.0 mm×50 mm. Separation was carried out using the columns PSS-SDV, 5μ, 10³ and also 10⁵ and 10⁶ each with ID 8.0 mm×300 mm. The sample concentration was 4 g/l, the flow rate 1.0 ml per minute. Measurement was made against PMMA standards.

Measurement of the Shrinkback (Test B)

Strips with a width of at least 30 mm and a length of 20 cm were cut parallel to the coating direction of the hotmelt. At application rates of 100 g/m², 4 strips each were laminated to one another, and, at 50 g/m², 8 strips were laminated to one another, so as to give comparable layer thicknesses. The specimen obtained in this way was then cut to a width of exactly 20 mm and was overstuck at each end with paper strips, with a spacing of 15 cm. The test specimen thus prepared was then suspended vertically at RT and the change in length was monitored over time until no further contraction of the sample could be found. The initial length reduced by the final value was then reported, relative to the initial length, as the shrinkback, in percent.

To measure the orientation after a longer time, the coated and oriented PSAs were stored in the form of swatches for a prolonged period and then analyzed.

Measurement of the Thermal Conductivity (Test C)

The thermal conductivity is measured by way of the copper block method. The PSA tape under test is adhered between two copper blocks. Two temperatures are measured at distances of 5 mm and 15 mm from the surface, and are extrapolated to the surface temperature. The thermal sensors used were Ni-CrNi thermocouples. The measurement apparatus is enclosed in PVC so as to avoid radiation losses. The heat is coupled in through an electrical heating element. The measuring installation is cooled with a copper water condenser. The measurement bodies (PSA tapes) possess dimensions of 25 mm×25 mm. The subject of the measurement was in each case the unbacked PSA tape film.

The thermal conductivity was calculated on the assumption that the density of thermal flow in the two blocks is the same and that the density of thermal flow of the PSA layer is likewise identical.
q_{Cu}=q_{PSA}
q_{Cu}=density of thermal flow in the copper blocks
q_{PSA}=density of thermal flow of the pressure-sensitive adhesive

If the densities of thermal flow in this equation are replaced by the phrase that describes thermal conduction in a planar wall, then it follows that:
λ_{Cu}×(T₁-T₂)/s=λ_{PSA}×(T_{b}-Tₜ)/sₛₐ
λ_{Cu}=conductivity of copper
λ_{PSA}=conductivity of the pressure-sensitive adhesive
s=distance between measurement points 1 and 2
sₛₐ=layer thickness of sample
T₁, T₂=temperatures at measurement points 1 and 2
T_{b}, Tₜ=surface temperatures of the top and bottom blocks.

This equation can be rephrased to give the thermal conductivity:
λ_{PSA}=λ_{c}_{ᵤ}×sₛₐ(T₁-T₂)/s×(T_{b}-Tₜ)

The thermal conductivity of copper was as follows: λ_{c}_{ᵤ}=372 W/mK

180° Bond Strength Test (Test D)

A strip, 20 mm wide, of an acrylate PSA coated onto a polyester or siliconized release paper was applied to steel plates. Depending on direction and drawing, longitudinal or transverse specimens were bonded to the steel plate. The PSA strip was pressed onto the substrate twice using a 2 kg weight. Immediately thereafter the adhesive tape was peeled from the substrate at 30 mm/min and at an angle of 180°. The steel plates were washed twice with acetone and once with isopropanol. The results of measurement are reported in N/cm and are averaged from three measurements. All measurements were carried out at room temperature under controlled-climate conditions.

Thermoconductive Materials Used:

Hollow Aluminum Oxide Spheres:

50 μm hollow spheres composed of aluminum oxide, having a thermal conductivity of 0.27 W/mk and a specific thermal resistance of 6×10¹³ Ωcm

Graphite:

Graphite KS 6 with an average particle size of 6 μm was tested. The average thermal conductivity of the material was 155 W/mk.

Sample Preparation

Polymer 1

A 200 L reactor conventional for free-radical polymerizations was charged with 2400 g of acrylic acid, 64 kg of 2-ethylhexyl acrylate, 6.4 kg of N-isopropylacrylamide and 53.3 kg of acetoneisopropanol (95:5). After nitrogen gas had been passed through the reactor for 45 minutes with stirring, the reactor was heated to 58° C. and 40 g of 2,2′-azoisobutyronitrile (AIBN) were added. The external heating bath was then heated to 75° C. and the reaction was carried out constantly at this external temperature. After a reaction time of 1 h a further 40 g of AIBN were added. After 5 h and 10 h, dilution was carried out each time with 15 kg of acetone/isopropanol (95:5). After 6 h and 8 h, 100 g portions of dicyclohexyl peroxydicarbonate (Perkadox 16®, Akzo Nobel) each in solution of 800 g of acetone were added. After a reaction time of 24 h the reaction was terminated and the batch cooled to room temperature. Determination of the molecular weight by test A gave an M_{w}=814 000 g/mol with a polydispersity M_{w}/Mₙ=5.2.

Polymer 2

A 200 L reactor conventional for free-radical polymerizations was charged with 1200 g of acrylic acid, 74 kg of 2-ethylhexyl acrylate, 4.8 kg of N-isopropylacrylamide and 53.3 kg of acetoneisopropanol (95:5). After nitrogen gas had been passed through the reactor for 45 minutes with stirring, the reactor was heated to 58° C. and 40 g of 2,2′-azoisobutyronitrile (AIBN) were added. The external heating bath was then heated to 75° C. and the reaction was carried out constantly at this external temperature. After a reaction time of 1 h a further 40 g of AIBN were added. After 5 h and 10 h, dilution was carried out each time with 15 kg of acetone/isopropanol (95:5). After 6 h and 8 h, 100 g portions of dicyclohexyl peroxydicarbonate (Perkadox 16®, Akzo Nobel) each in solution of 800 g of acetone were added. After a reaction time of 24 h the reaction was terminated and the batch cooled to room temperature.

Determination of the molecular weight by test A gave an M_{w}=801 000 g/mol with a polydispersity M_{w}/Mₙ=5.7.

### Example 1:

Polymer 1 was blended with 5% by weight of graphite KS 6, based on the polymer fraction.

### Example 2:

Polymer 1 was blended with 10% by weight of KS 6, based on the polymer fraction.

### Example 3:

Polymer 2 was blended with 20% by weight of hollow aluminum oxide spheres, based on the polymer fraction.

### Example 4:

Polymer 2 was blended with 10% by weight of KS 6, based on the polymer fraction.

i) Production of Specimens for Determining the Shrinkback

The PSAs in solution were concentrated on a Bersdorff concentrating extruder with a throughput of approximately 40 kg/h at a temperature of approximately 115° C. Following concentration, the residual solvent fraction was less than 0.5% by weight. The composition was then coated onto a 12 μm PET film coated beforehand with 1.5 g/m² silicone (polydimethylsiloxane), application of the composition taking place through a coathanger extrusion die with a die gap of 300 μm and a coating width of 33 cm, at a defined coating temperature (composition temperature) and a web speed of 10 m/min. For an application rate of 100 g/m² (PSA layer approximately 100 μm thick) a draw ratio of 3:1 was set, and for an application rate of 50 g/m² (PSA layer approximately 50 μm thick) a draw ratio of 6:1 was set.

The siliconized PET film is passed over a corotating steel roller which is cooled to 5° C. At the point of contact between the PSA film and the PET film, therefore, the PSA film is immediately cooled. The application rate was 50 or 100 g/m².

In an inline process, after a web section of approximately 5 m, the PSA tape is then crosslinked with electron beams.

For electron beam irradiation, crosslinking was carried out with an instrument from Electron Crosslinking AB, Halmstad, Sweden. The coated PSA tape was guided through under the Lenard window of the accelerator over a chill roll that is present as a standard feature. Within their radiation zone, the atmospheric oxygen was displaced by flushing with pure nitrogen. The web speed was in each case 10 m/min. Irradiation was carried out with an acceleration voltage of 200 kV.

To determine the shrinkback, test B was carried out.

To determine the thermal conductivity, test C was carried out. The bond strength was determined according to test D.

Results

In a first step, 2 polymers were prepared, with an average molecular weight M_{w} of about 800 000 g/mol. These PSAs were used to produce inventive examples 1 to 4. As the thermally conductive materials, a selection was made on the one hand of graphite and on the other hand of hollow aluminum oxide spheres.

In a first analysis the degree of orientation of the individual PSAs was determined. Therefore, in the text below, the shrinkback in the free film was determined according to test method B. The measured values are summarized in table 1.

TABLE 1
Overview of shrinkback values determined in the free film (test B).

| Example | Shrinkback in the free film (test B) |
|---|---|
| 1 | 70% |
| 2 | 72% |
| 3 | 66% |
| 4 | 68% |

All of the examples in table 1 exhibit a pronounced resilience. A further prerequisite for the inventive PSAs is the thermal conductivity. Below, therefore, the thermal conductivities of the individual examples were determined according to test method C. The values determined are summarized in table 2.

TABLE 2
Overview of thermal conductivity determined according to test C

| Example | Thermal conductivity (test C) in [W/mK] |
|---|---|
| 1 | 0.1094 |
| 2 | 0.1603 |
| 3 | 0.0733 |
| 4 | 0.1645 |
| Polymer 1 | 0.0524 |
| Polymer 2 | 0.0547 |

All thermal conductivities were determined with a layer thickness of 50 μm. The thermal conductivities of the base polymers 1 and 2 were likewise included. Table 2 shows that the inventive examples have good thermal conductivities and that in all cases the thermal conductivity was above that of the base polymers 1 and 2. The thermal conductivity can be varied by the addition of thermally conductive materials.

To ascertain the adhesive properties, the bond strength to steel was determined additionally. For these measurements as well the layer thickness of the PSA was 50 μm. The values measured are listed in table 3:

TABLE 3
Overview of bond strengths determined according to test D

| Example | Bond strength on steel (test D) in [N/cm] |
|---|---|
| 1 | 3.0 |
| 2 | 2.7 |
| 3 | 2.5 |
| 4 | 2.6 |

The values shown in table 3 make it clear that examples 1-4 possess pressure-sensitive adhesion properties. Through the amounts of the additive it is likewise possible to control the bond strength. High fractions of the filler material lower the bond strength.

1. A method of producing a pressure-sensitive adhesive article having at least one layer of a thermally conductive pressure-sensitive adhesive, wherein a layer of a thermally conductive pressure-sensitive adhesive that is anisotropic at least in respect of one property is produced in a coating process by stretching, drawing or compressing, said layer possessing in at least one direction along the plane of the layer a shrinkback of at least 3% in respect of the longitudinal extent of the layer, measured on the free pressure-sensitive adhesive layer.

2. The method of claim 1, wherein the coating process is a hotmelt roll coating process, a melt diecoating process or an extrusion coating process.

3. The method of claim 1, wherein the coating process comprises stretching or drawing on a stretchable carrier.

4. The method of claim 1, wherein the thermally conductive pressure-sensitive adhesive is coated onto one or both sides of a carrier.

5. The method of claim 4, wherein the carrier is a transfer tape, a release liner or a thermally conducting carrier material.

6. The method of claim 1, wherein the pressure-sensitive adhesive is based on polyacrylate and/or polymethacrylate.

7. The method of claim 6, wherein the pressure-sensitive adhesive is based to an extent of at least 50% by weight on at least one acrylic monomer selected from the group consisting of the compounds of the following formula: 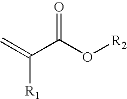
where R₁=H or CH₃ and the radical R₂=H or CH₃ or is selected from the group consisting of the branched or unbranched, saturated alkyl groups having 2-30 carbon atoms and the average molecular weight M_{w} of the pressure-sensitive adhesive is at least 200 000 g/mol.

8. The method of claim 1, wherein the pressure-sensitive adhesive comprises crosslinkers.

9. The method of claim 8, wherein the pressure-sensitive adhesive is crosslinked immediately after or during hotmelt coating.

10. The method of claim 1, wherein thermally conductive materials, are added to said pressure-sensitive adhesive.

11. The method of claim 10, wherein the thermally conductive materials are added in an amount of from 5% to 200% by weight, of the pressure-sensitive adhesive.

12. The method of claim 1 that the thermal conductivity of the pressure-sensitive adhesive is at least 0.05 W/mK.

13. The method of claim 1, wherein the thermal conductivity is anisotropic and is lower along a plane lying in the pressure-sensitive adhesive layer than transverse to the plane of the layer, it being at least 0.06 W/mK in a direction transverse to the plane of the layer.

14. The method of claim 1, wherein the pressure-sensitive adhesive comprises further substances or additives selected from the group consisting of aging inhibitors, light stabilizers, ozone protectants, fatty acids, plasticizers, nucleators, expandants, accelerators and fillers.

15. A pressure-sensitive adhesive article, for bonding two electrical parts, obtained by the method of claim 1.

16. The pressure-sensitive adhesive article of claim 15 in the form of a diecut.

17. The method of claim 8, wherein said crosslinkers are selected from the group consisting of difunctional or polyfunctional acrylates and/or methacrylates, difunctional or polyfunctional isocyanates and difunctional or polyfunctional epoxides.

18. The method of claim 10 wherein said thermally conductive materials are selected from the group consisting of metallic or ceramic materials, graphite, aluminum, aluminum oxide, aluminum nitride, titanium dioxide, titanium boride, silicon nitride, carbonitride and boron nitride.

19. The method of claim 18, wherein said thermally conductive materials are in powder form.

20. The method of claim 11, wherein said amount is between 6% and 50% by weight.
